(19) United States
(12) Patent Application Publication
(10) Pub. No.: US 2026/0163963 A1
(43) Pub. Date: Jun. 11, 2026

(54) Systems and Methods for Extranet Application Support

(71) Applicant: Zscaler, Inc., San Jose, CA (US)

(72) Inventors: Shyam Pullela, San Jose, CA (US); Chandra Nagarajan, San Jose, CA (US); Praveen Yadothare Sathyanarayan, Sunnyvale, CA (US); Prakash Seshadri, Fremont, CA (US); Joby Menon, Cupertino, CA (US)

(73) Assignee: Zscaler, Inc., San Jose, CA (US)

(21) Appl. No.: 18/973,657

(22) Filed: Dec. 9, 2024

(51) Int. Cl. H04L 67/63; H04L 45/12

(52) U.S. Cl. CPC H04L 67/63; H04L 45/12

(57) ABSTRACT

Systems and methods for extranet application support within a virtual private access system include receiving a request to access a resource from a user device associated with a customer of the cloud-based system, wherein the resource is located within one or more data centers associated with a partner of the customer; determining an optimal node of a plurality of nodes and an optimal tunnel of a plurality of tunnels for creating a connection between the user device and the resource; and creating a connection between the user device and the resources via the optimal node and the optimal tunnel.

### FIELD OF THE DISCLOSURE

The present disclosure generally relates to network and cloud security. More particularly, the present disclosure relates to systems and methods for extranet application support within a virtual private access system.

### BACKGROUND OF THE DISCLOSURE

Extranet application support is a critical service designed to ensure the smooth and secure operation of extranet platforms, which are private networks that organizations use to share information and collaborate with external partners, clients, or suppliers. Unlike an intranet, which is limited to internal employees, an extranet allows authorized external users to access specific parts of the organization's data or applications. Extranet application support faces several challenges, including security concerns like data breaches and complex access control, along with the need to comply with evolving regulations. Integration issues often arise due to compatibility problems and data synchronization across systems. Performance and scalability can be problematic, especially as the user base grows, causing slow load times and requiring infrastructure upgrades. User experience may suffer from complex navigation and limited support resources, while troubleshooting is complicated by the diversity of external systems. Maintaining effective communication between support teams, internal stakeholders, and external partners is essential but often difficult. Additionally, managing data privacy, ensuring infrastructure reliability, and implementing comprehensive backup and recovery plans are ongoing challenges that require strategic solutions.

### BRIEF SUMMARY OF THE DISCLOSURE

The present disclosure relates to systems and methods for extranet application support within a virtual private access system. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving a request to access a resource from a user device associated with a customer of the cloud-based system, wherein the resource is located within one or more data centers associated with a partner of the customer; determining an optimal node of a plurality of nodes and an optimal tunnel of a plurality of tunnels for creating a connection between the user device and the resource; and creating a connection between the user device and the resources via the optimal node and the optimal tunnel.

The steps can further include wherein the resource is an application hosted on one or more data centers associated with the partner. The determining can include steps of: determining an optimal node of the cloud-based system based on a health score of a plurality of nodes; and determining an optimal tunnel based on the optimal node and on a health score of a plurality of tunnels. The steps can include determining the health score of the plurality of nodes, wherein a health score of a node is based on Central Processing Unit (CPU) usage, memory usage, and tick slippage of the node. The steps can include determining the health score of the plurality of tunnels, wherein a health score of a tunnel is based on bandwidth usage and Smooth Round-Trip Time (SRTT) of the tunnel. The tunnel can be an Internet Protocol Secure (IPSec) tunnel between a partner data center and the cloud-based system. Creating the connection can include creating a connection from the cloud-based system to an agent application executing on the user device and creating a connection from the cloud-based system to the resource within the partners data center.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of a cloud-based private access service.

FIG. 6 is a flow diagram of an embodiment of the present private access system with extranet application support.

FIG. 7 is a flow diagram of an embodiment of the present private access system with extranet application support with respect to the function of onboarding a partner.

FIG. 8 is a flow diagram of the private access system with extranet application support providing extranet application access.

FIG. 9 is a flowchart of a process for extranet application support.

### DETAILED DESCRIPTION OF THE DISCLOSURE

Again, the present disclosure relates to systems and methods for extranet application support within a virtual private access system. The present systems provide a secure and efficient way for enterprises to connect with their partners' data centers and access hosted applications. Utilizing a virtual private access service, this solution leverages robust cloud infrastructure to ensure seamless and secure connectivity. The system intelligently selects the optimal paths through the cloud by evaluating network elements based on their health scores, which are determined by factors such as CPU usage, memory usage, tick slippage, SRTT, and bandwidth usage. This meticulous selection process ensures that the least loaded and most reliable paths are used, thereby optimizing resource utilization and enhancing overall performance and reliability. By normalizing and rescaling utilization metrics, the present methods ensure that the health scores accurately reflect the current state of the network elements, providing a comprehensive and dynamic approach to extranet application support.

### § 1.0 CYBERSECURITY MONITORING AND PROTECTION EXAMPLES

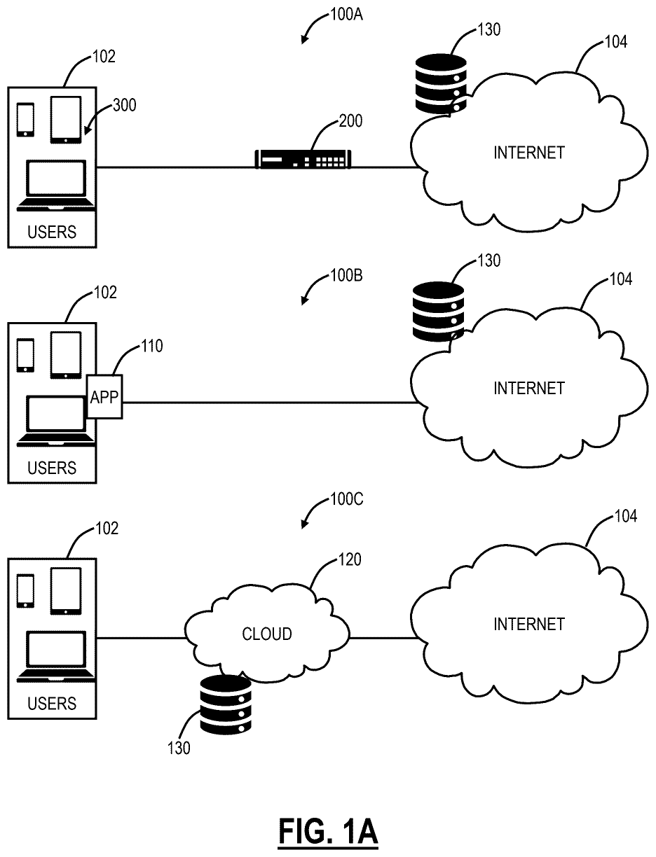

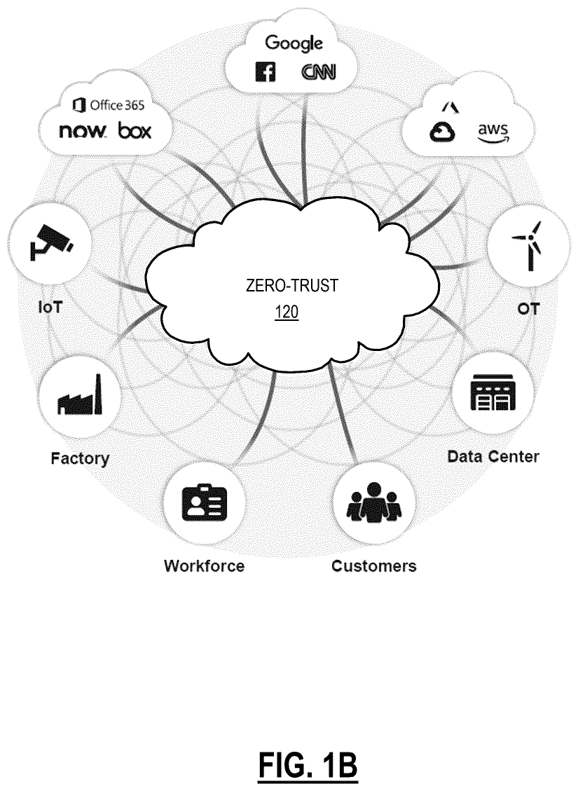

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

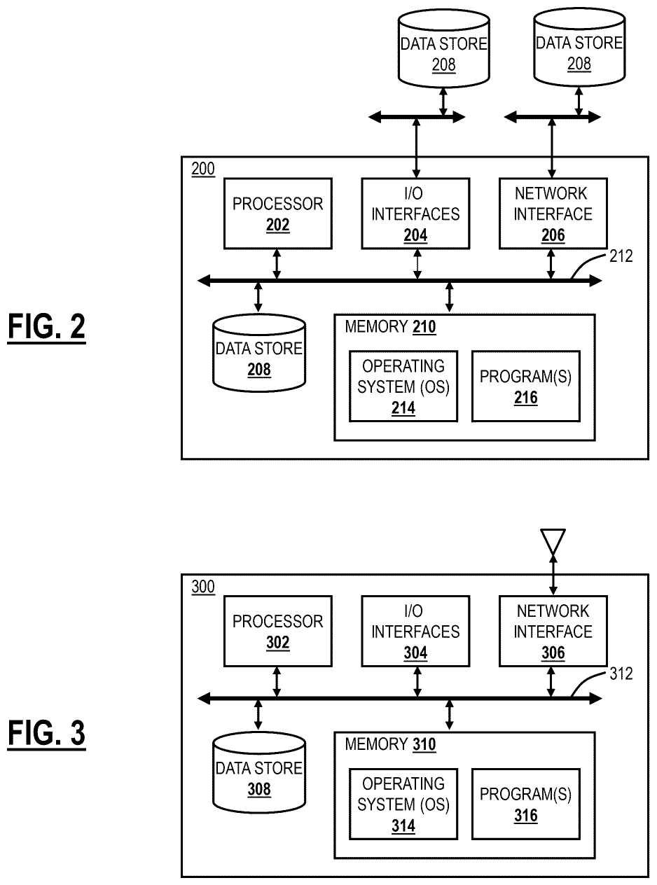

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication-not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates-in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time-before it reaches its destination-to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 EXAMPLE SERVER ARCHITECTURE

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 EXAMPLE COMPUTING DEVICE ARCHITECTURE

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 APPLICATION FOR TRAFFIC FORWARDING AND MONITORING

Again, the network configuration 100B includes an application 110 (agent application) that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

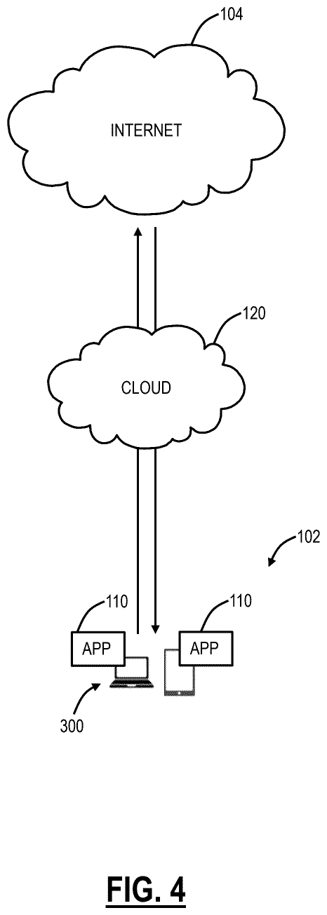

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 PRIVATE APPLICATION ACCESS

As described, Zscaler Private Access (ZPA), or the “private access service” as referenced herein, is a sophisticated, cloud-based service designed to securely connect users to internal applications without relying on traditional Virtual Private Networks (VPNs). It leverages the principles of zero trust security, ensuring that access is granted based on user identity, device posture, and other contextual information. This approach minimizes risk by providing users only the access they need, rather than exposing the entire network.

The private access service adopts a zero trust model, where no user or device, whether inside or outside the network, is automatically trusted. Every access request is evaluated and authenticated against stringent policies before any connection is established. Each request undergoes a thorough verification process, checking the user's identity, device health, and other contextual factors before granting access to specific applications. Users are granted the least privilege necessary to perform their tasks, meaning access is restricted to only the applications and data they need, significantly reducing the potential for unauthorized access or lateral movement within the network. Access rights can be dynamically adjusted based on real-time context, such as changes in user roles or detected security threats, ensuring continuous adherence to the least privilege principle.

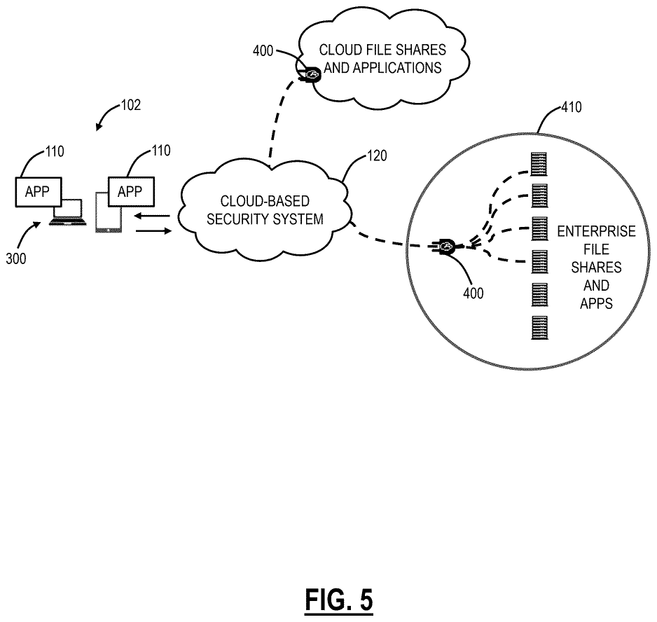

FIG. 5 is a flow diagram of a cloud-based private access service. The private access service's architecture is built around several critical components, each playing a vital role in ensuring secure and efficient access to applications. An app connector 400 is deployed within the enterprise Data Center (DC) 410, public cloud, or any location where applications are hosted. It establishes secure outbound connections to the cloud 120, eliminating the need for inbound firewall rules and reducing the attack surface. The app connector 400 maintains persistent connections between the cloud 120 and internal applications, ensuring applications remain hidden from the internet and preventing direct exposure. The agent application 110, installed on users' devices (laptops, smartphones, tablets), facilitates seamless and secure access to internal applications without requiring users to manually initiate a VPN connection. It provides a transparent user experience by automatically handling the connection process, ensuring constant and secure access to authorized applications.

A policy engine allows for centralized management of access policies. Administrators can define and enforce rules based on user identity, device posture, location, and other contextual information. Policies can be finely tuned to meet specific security requirements, enabling precise control over who can access what, when, and how. The private access service integrates seamlessly with various Identity Providers (IDPs) to support Single Sign-On (SSO) and Multi-Factor Authentication (MFA), ensuring that only authenticated users gain access to applications. By leveraging SSO and MFA, the private access service enhances security and simplifies the user authentication process, reducing the risk of credential theft and unauthorized access.

Unlike traditional network access methods that provide broad network access, the private access service segments access at the application level. Users can only access the specific applications they are authorized to use, minimizing exposure and potential attack vectors. This approach effectively isolates applications from one another, preventing unauthorized lateral movement and containing potential security incidents. Applications are not exposed to the internet, significantly reducing the attack surface. The private access service ensures that connections are established directly between the user and the application via secure, outbound-only connections, thereby mitigating the risk of external attacks and unauthorized access attempts.

Users experience seamless access to applications without the need to manually connect to VPNs. The private access service agent application 110 automatically handles the connection process, providing a smooth and uninterrupted experience. Users are not required to change their workflow or perform additional steps to connect to applications, resulting in higher productivity and user satisfaction. The private access service leverages Zscaler's global network of DCs to route traffic efficiently, ensuring minimal latency and high availability. By optimizing the routing of traffic through the cloud 120, the private access service delivers fast and reliable access to applications, regardless of the user's location.

The private access service further provides comprehensive logging and reporting of user activity, access patterns, and security events. These logs are invaluable for auditing, compliance, and forensic investigations. Detailed logs enable security teams to detect and respond to suspicious activities promptly, enhancing overall security posture. Administrators have access to real-time insights into application access and user behavior, allowing for proactive security management and quick troubleshooting of any access issues. Real-time data helps in making informed decisions regarding access policies and security measures, ensuring continuous improvement of security practices.

As a cloud-native service, the private access service scales effortlessly to accommodate growing user bases and application workloads without the need for additional hardware or complex configurations. The cloud-native architecture provides flexibility and agility, allowing organizations to adapt quickly to changing business needs and security requirements. The private access service integrates with various third-party security solutions and IT management tools through APIs, enhancing the overall security posture by enabling seamless data exchange and coordinated responses to security incidents. API integrations streamline operations, reduce administrative overhead, and improve the efficiency of security and IT management processes.

As described, the private access service is composed of several key components that work together to provide secure, seamless access to internal applications. These components ensure that users can access applications based on zero trust principles, without exposing the entire network. The primary components include the app connector 400, which is deployed within the enterprise DC 410, public cloud, or any location where applications are hosted. This connector establishes secure outbound connections to the cloud 120, eliminating the need for inbound firewall rules, thereby reducing the attack surface and simplifying firewall configurations. The app connector 400 maintains persistent connections between the cloud 120 and internal applications, ensuring that applications remain hidden from the internet and preventing direct exposure. This enhances security by ensuring that applications are accessed only through authenticated and authorized pathways.

Additionally, the agent application 110 is installed on users' devices, such as laptops, smartphones, and tablets. It facilitates seamless and secure access to internal applications without requiring users to manually initiate a VPN connection. The client provides a transparent user experience by automatically handling the connection process, ensuring constant and secure access to authorized applications. The policy engine allows for centralized management of access policies, enabling administrators to define and enforce rules based on user identity, device posture, location, and other contextual information. These policies can be finely tuned to meet specific security requirements, enabling precise control over who can access what, when, and how.

In an embodiment, a virtual private access method implemented by a cloud-based system, i.e., the cloud 120, includes receiving a request to access resources from a user device, wherein the resources are located in one of a public cloud and an enterprise network and the user device is remote therefrom on the Internet; forwarding the request to a central authority for a policy look up and for a determination of connection information to make an associated secure connection through the cloud-based system to the resources; receiving the connection information from the central authority responsive to an authorized policy look up; and creating secure tunnels between the user device and the resources based on the connection information. Prior to the receiving, a user executes an agent application on the user device, provides authentication, and provides the request with the application operating on the user device. The agent application can be configured to connect the user device to the cloud-based system, via an optimized cloud node based on a location of the user device. The resources can be communicatively coupled to a app connector operating on a computer and communicatively coupled between the resources and the cloud-based system. The virtual private access method can further include detecting the resources based on a query to the app connector. The app connector can be prevented from accepting inbound connections, thereby preventing access of the resources external from the public cloud or the enterprise network. The creating secure tunnels can include creating connections between one or more cloud nodes in the cloud-based system, wherein the one or more cloud nodes do not participate in a key exchange, and the one or more cloud nodes do not have data access to traffic on the secure tunnels. The creating secure tunnels can include creating connections between one or more cloud nodes in the cloud-based system, wherein the one or more cloud nodes create the secure tunnels based on a combination of a client-side certificate and a server-side certificate. The secure tunnels can be created through software on the user device, the cloud-based system, and an app connector operating on a computer associated with the resources, thereby eliminating dedicated hardware for virtual private network connections.

In another embodiment, a cloud-based system adapted to implement virtual private access includes one or more cloud nodes communicatively coupled to one another; wherein each of the one or more cloud nodes includes one or more processors and memory storing instructions that, when executed, cause the one or more processors to receive a request to access resources from a user device, wherein the resources are located in one of a public cloud and an enterprise network and the user device is remote therefrom on the Internet; forward the request to a central authority for a policy look up and for a determination of connection information to make an associated secure connection through the cloud-based system to the resources; receive the connection information from the central authority responsive to an authorized policy look up; and create secure tunnels between the user device and the resources based on the connection information. Prior to reception of the request, a user executes an agent application on the user device, provides authentication, and provides the request with the application operating on the user device. The agent application can be configured to connect the user device to the cloud-based system, via an optimized cloud node based on a location of the user device. The resources can be communicatively coupled to a app connector operating on a computer and communicatively coupled between the resources and the cloud-based system. The memory storing instructions that, when executed, can further cause the one or more processors to detect the resources based on a query to the app connector. The app connector can be prevented from accepting inbound connections, thereby preventing access of the resources external from the public cloud or the enterprise network. The secure tunnels can be created through connections between one or more cloud nodes in the cloud-based system, wherein the one or more cloud nodes do not participate in a key exchange, and the one or more cloud nodes do not have data access to traffic on the secure tunnels. The secure tunnels can be created through connections between one or more cloud nodes in the cloud-based system, wherein the one or more cloud nodes create the secure tunnels based on a combination of a client-side certificate and a server-side certificate. The secure tunnels can be created through software on the user device, the cloud-based system, and an app connector operating on a computer associated with the resources, thereby eliminating dedicated hardware for virtual private network connections.

Software stored in a non-transitory computer readable medium including instructions executable by a system, which in response to such execution causes the system to perform operations including receiving a request to access resources from a user device, wherein the resources are located in one of a public cloud and an enterprise network and the user device is remote therefrom on the Internet; forwarding the request to a central authority for a policy look up and for a determination of connection information to make an associated secure connection through the cloud-based system to the resources; receiving the connection information from the central authority responsive to an authorized policy look up; and creating secure tunnels between the user device and the resources based on the connection information. The resources can be communicatively coupled to an app connector operating on a computer and communicatively coupled between the resources and the cloud-based system, and wherein the instructions executable by the system, which in response to such execution can further cause the system to perform operations including detecting the resources based on a query to the app connector.

### § 6.0 CLOUD-BASED INTERNET ACCESS SERVICE

Zscaler Internet Access (ZIA), i.e., the cloud-based internet access service described herein, is a cloud-based security platform designed to protect and manage internet traffic for enterprises, providing comprehensive security and compliance capabilities. Unlike traditional security solutions that rely on physical hardware and on-premises infrastructure, ZIA operates entirely in the cloud, offering scalability and ease of deployment. ZIA functions as a secure internet gateway, inspecting all incoming and outgoing traffic to prevent threats and ensure data protection. It integrates various security features such as secure web gateway, cloud firewall, Data Loss Prevention (DLP), and advanced threat protection, all delivered through a unified platform. By routing traffic through the cloud 120, ZIA enables secure, fast, and reliable internet access for users regardless of their location. This approach not only enhances security but also simplifies IT management, reduces costs, and improves user experience by maintaining consistent security policies across the entire organization.

### § 7.0 EXTRANET APPLICATION SUPPORT

In the private access service architecture, an app connector 400 plays a crucial role within the system by facilitating the connection between private access traffic and a specified application. This app connector 400 operates within the customer's network environment. Typically, a standard application is hosted on an application server and is accessible through an IP address within the customer's intranet. However, there are certain applications, known as extranet applications, which are not directly reachable via the intranet. These applications require access through an Internet Protocol Security (IPSec) tunnel, hence their designation as extranet applications. To effectively support these extranet applications, the app connector 400 must possess enhanced capabilities that enable it to manage the necessary logistics for establishing a connection to the application server through the IPSec tunnel. This additional functionality ensures that the private access system can securely and efficiently extend its connectivity to applications that reside outside the immediate intranet environment.

To address the challenge of extending Zero Trust Network Access (ZTNA) to the private applications of business partners, the present disclosure introduces extranet application support to the private access system of the cloud 120. This feature allows trusted partners of cloud customers to seamlessly establish IPSec tunnels directly to DCs of the cloud 120. This setup ensures that only authenticated and authorized users can access the applications, thereby reducing the risks associated with external access.

Extranet application support significantly enhances scalability by offloading the task of tunnel termination to the cloud. This offloading allows for a more efficient use of resources and supports high availability by enabling tunnels to connect to multiple cloud DCs. That is, a partner location can connect via IPSec tunnels to a plurality of cloud DCs, allowing for fallback mechanisms and traffic steering based on metrics such as tunnel health and the like. As a result, the solution offers seamless redundancy, ensuring continuous and reliable connectivity.

Additionally, this solution provides a scalable, secure, and low-maintenance approach to partner connectivity. It allows customers to easily onboard new partners, and facilitating quicker collaboration and integration. By streamlining the process of establishing secure connections, extranet application support enables businesses to collaborate more effectively and respond to new partnership opportunities with greater agility.

Extranet application support offers several key benefits that revolutionize how organizations connect with their business partners. First, it ensures secure partner application access. By allowing organizations to connect to a partner's private applications through the cloud 120 without exposing their internal network, it significantly mitigates security risks. This secure connection is facilitated through the clouds Zero Trust Exchange (ZTE) platform which is made up of the security services described herein, which enforces strict authentication and authorization protocols.

Onboarding new business partners becomes streamlined with extranet application support as outlined further herein. Instead of the traditional, labor-intensive process of manually configuring VPNs for each new partner, this feature allows partners to connect via IPSec to the ZTE platform, i.e., the cloud 120. This drastically reduces the complexity and time required for onboarding, enabling organizations to quickly and efficiently integrate new partners.

Managing connectivity for multiple business partners is simplified through centralized traffic routing and access control. Organizations often have numerous partners, each requiring unique application access. With extranet application support, they can reduce the operational burden associated with managing DNS and routing configurations for each partner by consolidating these tasks within the cloud 120. This centralization streamlines operations and enhances efficiency.

High availability and redundancy for critical partner applications are assured through active-active IPSec tunnels and seamless failover capabilities. This means that even during network failures, access to essential partner applications remains uninterrupted, ensuring continuous business operations and minimizing downtime. Moreover, the present systems and methods facilitate cross-regional access to partner applications. Organizations with global operations can optimize performance through location-aware routing, ensuring that users connect to the nearest DC. This reduces latency and improves the overall user experience, particularly when accessing partner applications hosted in various regions around the world.

Thus, the private access system extranet application support transforms how organizations securely connect with their business partners. By applying zero trust principles, it streamlines onboarding processes, enhances security, and improves agility, all while significantly reducing operational complexity. This innovative solution empowers organizations to collaborate more effectively and respond swiftly to new partnership opportunities.

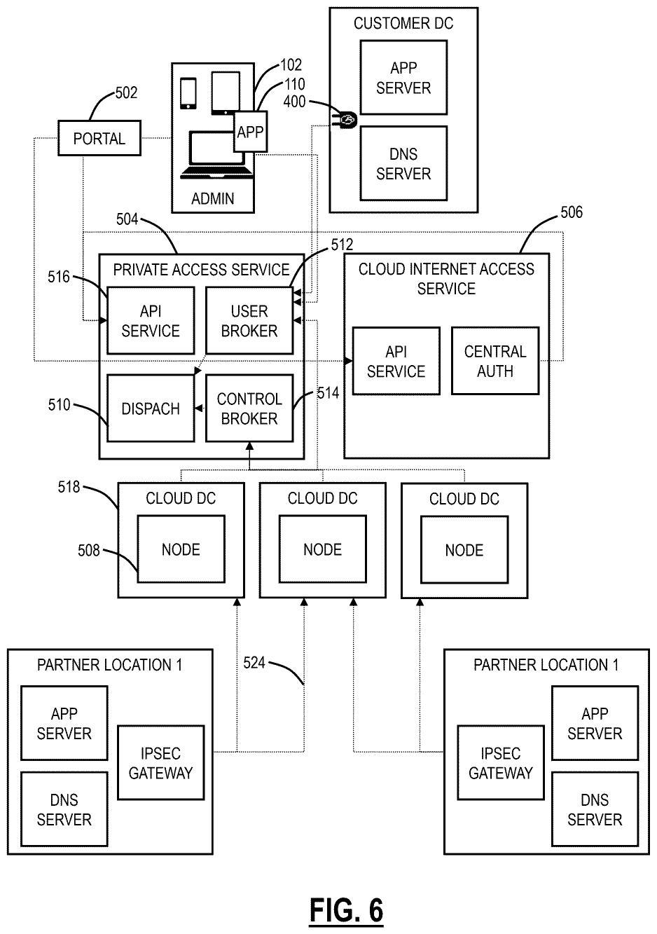

FIG. 6 is a flow diagram of an embodiment of the present private access system with extranet application support. Various components are highlighted in the diagram shown in FIG. 6. The process of onboarding a new partner location begins with an administrator logging into a portal 502. Here, the admin is responsible for onboarding the partner's location applications, assigning authorized users to these applications, and configuring associated policies. Additionally, the admin can set up app segments, server groups, and app connector 400 configurations related to the partner's IPSec tunnels. This process is simplified by creating a server group for each location, with the location embedded within the server group. By binding an app segment to a server group, the system effectively associates an application with a specific location and, consequently, with an IPSec tunnel. The portal 502 offers robust functionality for IPSec configuration, location management, and forwarding rules. It also supports managing tunnel events, firewall settings, DNS configurations, and logging functionalities. Furthermore, the system provides forwarding rules to route traffic between the private access service and the internet. The portal 502 also facilitates partner configuration management, streamlining the overall process. The portal 502 can be associated with both the private access service 504 and the cloud-based internet access service 506, allowing configuration for each.

The nodes 508 of the cloud 120 are designed to support both multi-tenancy and multi-partner environments for a single customer. They logically separate traffic between different tenancies while terminating IPSec tunnels, ensuring secure and efficient connectivity. In various embodiments, load balancers host virtual IP nodes and forwards traffic accordingly.

The dispatcher 510 is a critical component in the private access service 504, responsible for routing and connecting the agent applications 110 with the app connectors 400 through the user broker 512. The dispatcher 510 assists the user broker 512 by associating a partner's location with an IPSec tunnel when an agent application 110 connects to a user broker 512.

The user broker 512 functions as a bridge, directing traffic from the agent application 110 through the tunnel to a specific node 508 in a designated DC 518. It queries the dispatcher 510 to identify the node 508 in a DC 518 that has an IPSec tunnel to the partner's location. Using this information, the user broker establishes the tunnel to the node 508, routing the user's traffic appropriately.

The control broker 514 acts as an intermediary, passing information from the node 508 to the dispatcher 510. The node 508 establishes a connection with the control broker 514 to share tunnel status and periodic health metrics such as latency and Round-Trip Time (RTT). This data enables the dispatcher 510 to select the tunnel with the optimal health for routing traffic. This process is further described herein.

The private access API service 516 includes multiple modules grouped together to provide various functionalities. It offers UI APIs, internal module APIs, and synchronizes data from the cloud-based internet access service 506 regarding partners, locations, and location groups. This information is reflected in the UI part of the app segment configuration, ensuring seamless integration and management.

In various embodiments, one or more traffic selectors are contemplated. A plurality of IPSec tunnels 524 can be between one partner location and various cloud DCs 518. In such scenarios, if the partners IPSec gateway is not a stateful firewall device, it may not be able to steer response traffic back to the correct tunnel. By negotiating a unique IP address for each IPSec tunnel, a cloud 120 side traffic selector can control traffic steering to a right IPSec tunnel on the partners IPSec gateway. Partners can also configure their traffic selectors to the network subnet that they expect to expose to the customer. This helps to steer the traffic from the cloud 120 to the right IPSec tunnel.

In the extranet application access use case, the private access service 504 utilizes the cloud-based internet access service 506 infrastructure to access applications hosted in the partner's DCs. At any given time, there may be multiple paths through the cloud 120 to reach these applications. To ensure optimal resource utilization, it is crucial to select the network elements along the least loaded path. This selection process is facilitated by assigning a unique score to each potential path, with scores ranging from 0 to 100. A score of 0 indicates a least preferred path or a heavily utilized system, while a score of 100 signifies the most preferred path or a currently underutilized system. This scoring system allows for efficient and effective routing of traffic, ensuring that resources are used in the most balanced and efficient manner possible. In various embodiments, the scores can be generated and assigned for nodes 508 and IPSec tunnels 524.

There can be several potential paths leading to partner DCs that host the same application. To ensure optimal performance and reliability, the present systems employ a selection process for these paths. Initially, the systems will evaluate the health scores of all available nodes 508. It will then select the node 508 that has the highest health score, indicating the most reliable and least congested path. Once the most suitable node 508 is identified, the systems will further scrutinize the available IPSec tunnels associated with the node 508. Among these tunnels, the systems will choose the one with the highest health score to establish the connection. This meticulous two-tiered selection process ensures that the chosen path to the partner DC is not only optimal in terms of performance but also maximizes reliability and efficiency, thus enhancing the overall user experience.

Resource utilization for network elements is generally expressed as a percentage. In this context, a 0% utilization rate indicates that the network element is underutilized, which is considered ideal as it suggests there is ample capacity available. On the other hand, a 100% utilization rate signifies full exhaustion of the network element's resources, which is undesirable as it indicates no remaining capacity and potential performance issues.

The relationship between resource utilization and the health score of a network element is inversely related. When resource utilization is low, the health score should be high, reflecting the availability of resources and the element's ability to handle additional load. Conversely, when resource utilization is high, the health score should be low, indicating that the network element is heavily loaded and may not perform optimally under additional stress.

Moreover, when evaluating the health score of a network element that comprises multiple resources, it is important to consider the utilization of each individual resource. If any single resource within the network element reaches its maximum utilization, the overall health score should significantly drop. This approach ensures that even if most resources are underutilized, the presence of a bottleneck in one resource is accurately reflected in the health score, thereby providing a more comprehensive and realistic assessment of the network element's performance and capacity.

To achieve the desired health score based on this behavior, the present systems use the geometric mean of the inverse of resource utilization.

$$\sqrt[n]{( 100 - RU 1 ) * ( 100 - RU 2 ) … ( 100 - RUn )}$$

Where RU represents resource utilization.

For example, the table below displays the health scores corresponding to different utilization values for Resource-1 and Resource-2.

| Ru1 | Ru2 | Score |
|---|---|---|
| 0 | 0 | 100 |
| 0 | 10 | 95 |
| 10 | 0 | 95 |
| 20 | 20 | 80 |
| 20 | 40 | 69 |
| 50 | 50 | 50 |
| 60 | 80 | 28 |
| 0 | 100 | 0 |
| 100 | 0 | 0 |
| 100 | 100 | 0 |

In the above table, observe that if any resource reaches 100% utilization, the overall score is reduced to 0.

In certain scenarios, resource utilization up to a specific threshold can be considered healthy and should not negatively impact the health score. For instance, if a resource operates efficiently up to a certain level of utilization, this range should be factored into the health score calculation to reflect its optimal performance.

Conversely, some resources may become extremely unhealthy when their utilization reaches a particular level. In such cases, the health score should drop significantly to reflect the resource's decreased efficiency and heightened risk of failure.

To illustrate, consider Resource-1, where utilization up to 40% is deemed healthy. Utilization within this range should not reduce the health score at all. However, for Resource-2, if utilization above 60% is considered unhealthy, then any utilization beyond this point should drastically reduce the health score, potentially bringing it down to zero.

This approach can be implemented by normalizing the utilization percentage so that the healthy limit is rescaled from 0 to 100 before being applied in the health score calculation. For Resource-1, utilization from 40% to 100% must be rescaled to a range of 0 to 100. Conversely, for Resource-2, utilization from 0% to 60% must be rescaled to a range of 0 to 100. This normalization ensures that the health score accurately reflects the resource's performance across different utilization levels, thereby providing a more precise and meaningful assessment of its operational status.

When the normalized utilization is used to calculate the health score, the results are as follows:

| | | | Score for Normalized |
|---|---|---|---|
| Ru1 | Ru2 | Original Score | Utilization |
| 0 | 0 | 100 | 100 |
| 0 | 10 | 95 | 91 |
| 10 | 0 | 95 | 100 |
| 20 | 20 | 80 | 81 |
| 20 | 40 | 69 | 58 |
| 50 | 50 | 50 | 37 |
| 60 | 80 | 28 | 0 |
| 0 | 100 | 0 | 0 |
| 100 | 0 | 0 | 0 |
| 100 | 100 | 0 | 0 |

Since the upper threshold for the Ru2 was set to 60%, when Ru2 is 60% and above, the overall score is reduced to 0.

In various embodiments, the health score for a node 508 is calculated based on CPU usage, memory usage, and tick slippage. These parameters are monitored every second, and the average of the past 30 readings is used in the health score calculation.

The CPU usage for the node 508 ranges from 0 to 100%. By default, CPU usage up to 60% is considered healthy, and any usage beyond this threshold should be factored into the health score calculation. To accurately reflect this, CPU usage from 60% to 100% is normalized by rescaling it to 0 to 100% before being included in the node 508 health score calculation.

Similarly, memory usage for the node 508 also ranges from 0 to 100%. Memory usage up to 60% is deemed healthy by default, and any usage beyond this threshold should be considered in the health score calculation. Memory usage from 60% to 100% is normalized by rescaling it to 0 to 100% before being factored into the node 508 health score calculation.

Tick slippage for the node 508 ranges from 0 to 100. Internally, one tick is measured every 10 milliseconds, meaning 100 ticks should be measured per second. If any CPU processes take longer than this, causing a tick miss, it will be added to tick slippage. By default, tick slippage greater than 20 is considered an unhealthy operating condition. To ensure accurate health scoring, tick slippage from 0 to 20 will be normalized by rescaling it to 0 to 100 before being included in the node 508 health score calculation.

The following table shows a plurality of example node 508 health scores.

| Avg CPU | Avg Memory | Avg Tick | Node |
|---|---|---|---|
| Usage | Usage | Slippage | Score |
| 0 | 0 | 0 | 100 |
| 10 | 0 | 0 | 100 |
| 0 | 10 | 0 | 100 |
| 60 | 60 | 0 | 100 |
| 60 | 60 | 5 | 90 |
| 60 | 60 | 10 | 79 |
| 70 | 80 | 0 | 72 |
| 70 | 80 | 10 | 57 |
| 80 | 80 | 10 | 50 |
| 100 | 0 | 0 | 0 |
| 0 | 100 | 0 | 0 |
| 0 | 0 | 20 | 0 |
| 0 | 0 | 100 | 0 |

The node 508 score feature and the default values used in its calculation can be specified in a configuration file to ensure these settings are retained across process restarts.

The health score for an IPSec tunnel is calculated based on bandwidth usage of the tunnel and the Smooth Round-Trip Time (SRTT) to the TCP applications in the extranet. The average tunnel bandwidth over a 30-second interval is measured, and the SRTT average is calculated each time the location update for the IPSec tunnel is sent to the cloud 120. These averages are used in the calculation of the tunnel's health score.

The SRTT is measured in milliseconds. By default, an SRTT of up to 2000 milliseconds is considered within an acceptable range and should be factored into the health score calculation. To achieve this, SRTT values from 0 to 2000 milliseconds are normalized by rescaling them to a range of 0 to 100 before being included in the IPSec tunnel health score calculation. Any SRTT values above 2000 milliseconds are set to 100.

For bandwidth usage, the maximum bandwidth for encrypted traffic on an IPSec tunnel is approximately 400 Mbps. Bandwidth usage from 0 to 350 Mbps is normalized by rescaling it to a range of 0 to 100 before being included in the IPSec tunnel health score calculation. Any bandwidth usage above 350 Mbps is set to 100.

The following table shows a plurality of example IPSec tunnel health scores.

| Avg Bandwidth Usage | Avg SRTT | IPSec Tunnel Score |
|---|---|---|
| 0 | 0 | 100 |
| 0 | 180 | 95 |
| 150 | 0 | 76 |
| 150 | 450 | 67 |
| 350 | 10 | 0 |
| 150 | 2000 | 0 |

The IPSec tunnel health score feature and the default values used in its calculation can be specified in a configuration file to ensure these settings are retained across process restarts. Based on the scoring processes described herein, the systems can efficiently select the optimal path to connect a user to an application that is on a partners DC.

### § 7.1 Extranet Application Partner Onboarding

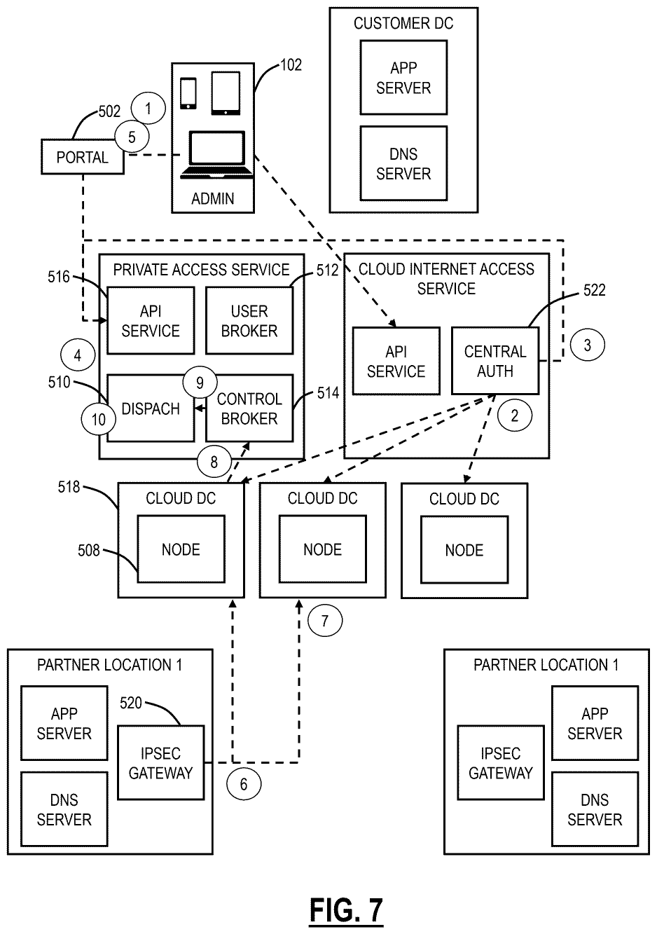

FIG. 7 is a flow diagram of an embodiment of the present private access system with extranet application support with respect to the function of onboarding a partner. The diagram shown in FIG. 7 displays various steps (steps 1-10) that are followed to onboard a partner of a cloud customer, i.e., a customer of the cloud 120 and its various security services. In a first step (step 1), the customers administrator utilizes the portal 502 and creates a new partner, partner location(s), and associates IPSec credentials. The administrator can further configure an IP address poll for utilizing as a cloud-side IPSec traffic selector.

In a second step (step 2), once the location is created, the cloud-based internet access service pushes the IPSec configuration to all nodes 508 in all cloud DCs 518. Based thereon, the nodes 508 are ready to accept new tunnels from partner IPSec gateways 520. In a third step (step 3), when a partner's location is created, the central authority 522 syncs location, location group, partner information, and additional information with the private access service. Location information from the central authority 522 includes the location group. In a fourth step (step 4) all locations are organized under a location group for administrators to select while creating an app segment.

In a fifth step (step 5), the customers administrator, in the portal 502, creates an app segment and can associate the location group for the app segment. The administrator can further create user access policies associated with the applications within the partner location.

In a sixth step (step 6), the partners administrator configures their IPSec gateway 520 to trigger an IPSec tunnel to a cloud DC 518. Also, the partners administrator configures additional IPSec tunnels for other cloud DCs 518 for redundancy. In a seventh step (step 7), a node 508 in a cloud DC 518 receives IPSec tunnel negotiation requests from the partners IPSec gateway 520. The node 508 establishes the tunnel with the partners IPSec gateway 520.

Next, in an eight step (step 8), since the location belongs to a partner, the node 508 connects a control broker 514 and shares location ID, node ID, tunnel ID, geo location, and periodic tunnel health. The control broker 514 then, in a ninth step (step 9), relays the information to the dispatcher 510. Finaly, in a tenth step (step 10), the dispatcher 510 can, responsive to receiving traffic from a user's agent application 110, provide information to the user broker 512 including an associated node 508 so that it can establish a tunnel connection to reach the partner application associated with the traffic.

### § 7.2 Extranet Application Support Functionality

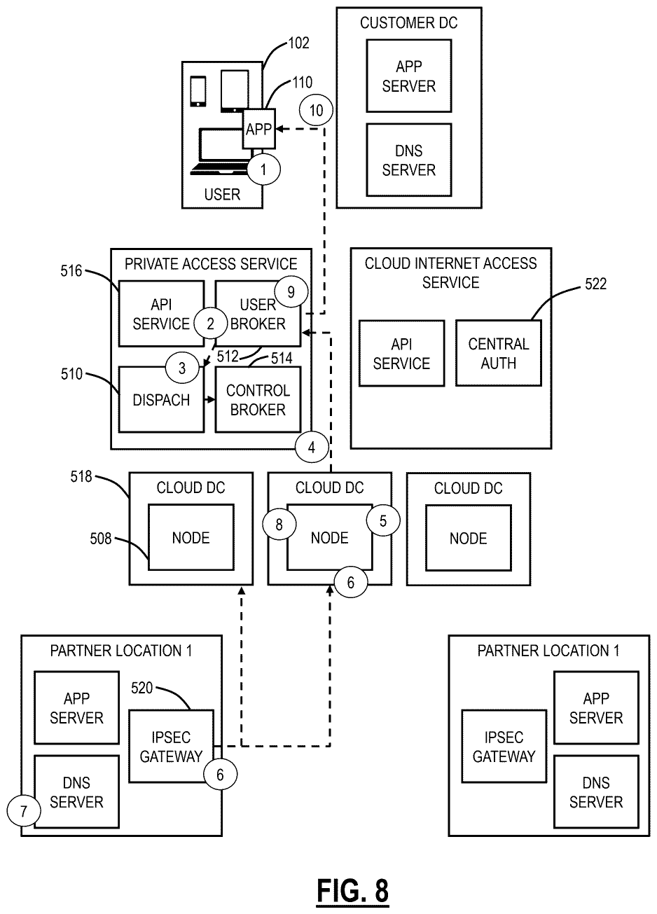

FIG. 8 is a flow diagram of the private access system with extranet application support providing extranet application access. The diagram shown in FIG. 8 displays various steps (steps 1-10) that are followed by the system to provide extranet application access. That is, the steps outline an embodiment of the traffic flow for providing access for customers users to applications that are within a partner's location. In a first step (step 1), a customer's user utilizing a computing device 300 that is executing the agent application 110 tries to access a partners application. The agent application 110 then checks with the private access service and the cloud-based internet access service and confirms the application's reachability and if the user 102 has access based on policy. if the user is allowed to access the application, the agent application sends a request to create a tunnel with the user broker 512. In a second step (step 2), the user broker 512 is aware that the application is accessible via the partner's location. Based thereon, the user broker 512 asks the dispatcher 510 to request for a node 508 to connect to the control broker 514. The dispatcher 510 has the tunnels status, health information for a partners location and tunnel, DC geo location, etc.

Based on this information, in a third step (step 3), the dispatcher 510 sends a request to the control broker 514 which has a control connection with a selected node 508. After the control broker 514 requests to open a connection, in a fourth step (step 4), the node 508 establishes a TLS connection with the user broker 512. In a fifth step (step 5) the control broker 514 sends a create request to the node 508 over a TLS connection with the partners location ID, tunnel ID, applications hostname, port number to connect, and other information. The node 508 then creates a TCP connection request to the application. since the DNS must be resolved, a DNS resolve request will be triggered along with required metadata to route the DNS request to the correct IPSec tunnel.

In a sixth step (step 6), the partners IPSec gateway 520 decrypts and recovers inner IP packets, and forwards the IP packets to the corresponding DNS server in the partners location. In a seventh step (step 7), the DNS server responds to the IPSec gateway which forwards the packet to the correct tunnel based on a traffic selector. In an eighth step (step 8), the node 508 receives the packet, decrypts, and recovers inner DNS response packet. Since the destination IP of the packet is to the node 508 traffic selector IP, the node 508 consumes the packet and resolves the domain name to an IP. After DNS resolution, a TCP handshake is completed with the requested application, and a tunnel ready message is sent to the control broker 514 indicating it is ready to process packets. In a ninth step (step 9), the user broker 512 bridges return traffic from the node 508 back to the agent application 110. Finally, in a tenth step (step 10), the agent application 110 receives the application payload and reassembles the packet back to the IP and forwards the packet to the appropriate application.

It will be appreciated that the described steps describe a non-limiting embodiment of the present systems and methods for providing extranet application support to customers of the cloud 120.

### § 7.3 Extranet Application Support Process

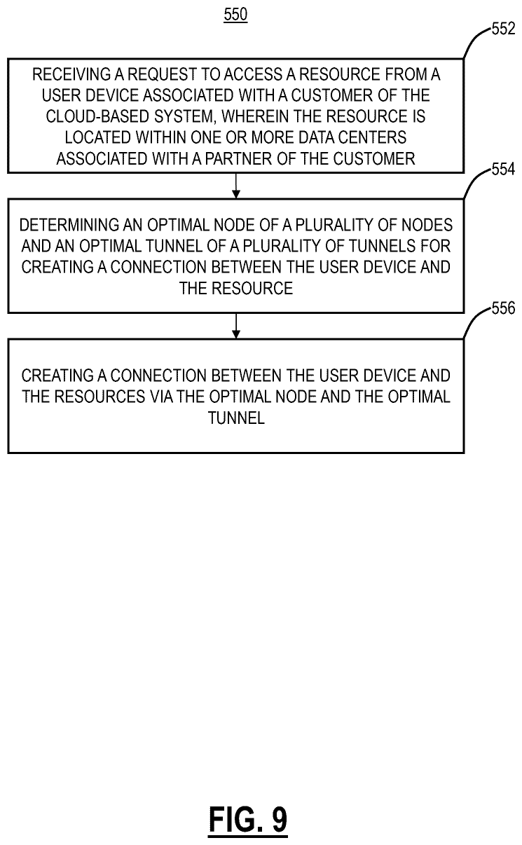

FIG. 9 is a flowchart of a process 550 for extranet application support. The process 550 can be contemplated as a method having steps, a processing device configured to implement the steps, a cloud-based system configured to implement the steps, and as a non-transitory computer-readable medium storing instructions for programming one or more processors to execute the steps. The process 550 includes receiving a request to access a resource from a user device associated with a customer of the cloud-based system, wherein the resource is located within one or more data centers associated with a partner of the customer (step 552); determining an optimal node of a plurality of nodes and an optimal tunnel of a plurality of tunnels for creating a connection between the user device and the resource (step 554); and creating a connection between the user device and the resources via the optimal node and the optimal tunnel (step 556).

The process 550 can further include wherein the resource is an application hosted on one or more data centers associated with the partner. The determining can include steps of: determining an optimal node of the cloud-based system based on a health score of a plurality of nodes; and determining an optimal tunnel based on the optimal node and on a health score of a plurality of tunnels. The steps can include determining the health score of the plurality of nodes, wherein a health score of a node is based on Central Processing Unit (CPU) usage, memory usage, and tick slippage of the node. The steps can include determining the health score of the plurality of tunnels, wherein a health score of a tunnel is based on bandwidth usage and Smooth Round-Trip Time (SRTT) of the tunnel. The tunnel can be an Internet Protocol Secure (IPSec) tunnel between a partner data center and the cloud-based system. Creating the connection can include creating a connection from the cloud-based system to an agent application executing on the user device and creating a connection from the cloud-based system to the resource within the partners data center.

### § 8.0 PROCESSING CIRCUITRY AND NON-TRANSITORY COMPUTER-READABLE MEDIUMS

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 9.0 CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner-whether collectively, in subsets, or individually-thereby broadening the range of potential embodiments.

What is claimed is:

1. A method implemented by a cloud-based system, the method comprising steps of:
receiving a request to access a resource from a user device associated with a customer of the cloud-based system, wherein the resource is located within one or more data centers associated with a partner of the customer;
determining an optimal node of a plurality of nodes and an optimal tunnel of a plurality of tunnels for creating a connection between the user device and the resource; and
creating a connection between the user device and the resources via the optimal node and the optimal tunnel.

2. The method of claim 1, wherein the resource is an application hosted on one or more data centers associated with the partner.

3. The method of claim 1, wherein the determining comprises steps of:
determining an optimal node of the cloud-based system based on a health score of a plurality of nodes; and
determining an optimal tunnel based on the optimal node and on a health score of a plurality of tunnels.

4. The method of claim 3, wherein the steps include determining the health score of the plurality of nodes, wherein a health score of a node is based on Central Processing Unit (CPU) usage, memory usage, and tick slippage of the node.

5. The method of claim 3, wherein the steps include determining the health score of the plurality of tunnels, wherein a health score of a tunnel is based on bandwidth usage and Smooth Round-Trip Time (SRTT) of the tunnel.

6. The method of claim 1, wherein the tunnel is an Internet Protocol Secure (IPSec) tunnel between a partner data center and the cloud-based system.

7. The method of claim 1, wherein creating the connection includes creating a connection from the cloud-based system to an agent application executing on the user device and creating a connection from the cloud-based system to the resource within the partners data center.

8. A non-transitory computer-readable medium comprising instructions that, when executed, cause one or more processors associated with a cloud-based system to perform steps of:
receiving a request to access a resource from a user device associated with a customer of the cloud-based system, wherein the resource is located within one or more data centers associated with a partner of the customer;
determining an optimal node of a plurality of nodes and an optimal tunnel of a plurality of tunnels for creating a connection between the user device and the resource; and
creating a connection between the user device and the resources via the optimal node and the optimal tunnel.

9. The non-transitory computer-readable medium of claim 8, wherein the resource is an application hosted on one or more data centers associated with the partner.

10. The non-transitory computer-readable medium of claim 8, wherein the determining comprises steps of:
determining an optimal node of the cloud-based system based on a health score of a plurality of nodes; and
determining an optimal tunnel based on the optimal node and on a health score of a plurality of tunnels.

11. The non-transitory computer-readable medium of claim 10, wherein the steps include determining the health score of the plurality of nodes, wherein a health score of a node is based on Central Processing Unit (CPU) usage, memory usage, and tick slippage of the node.

12. The non-transitory computer-readable medium of claim 10, wherein the steps include determining the health score of the plurality of tunnels, wherein a health score of a tunnel is based on bandwidth usage and Smooth Round-Trip Time (SRTT) of the tunnel.

13. The non-transitory computer-readable medium of claim 8, wherein the tunnel is an Internet Protocol Secure (IPSec) tunnel between a partner data center and the cloud-based system.

14. The non-transitory computer-readable medium of claim 8, wherein creating the connection includes creating a connection from the cloud-based system to an agent application executing on the user device and creating a connection from the cloud-based system to the resource within the partners data center.

15. A cloud-based system comprising:
one or more processors; and
memory storing computer-executable instructions that, when executed, cause the one or more processors to:
receive a request to access a resource from a user device associated with a customer of the cloud-based system, wherein the resource is located within one or more data centers associated with a partner of the customer;
determine an optimal node of a plurality of nodes and an optimal tunnel of a plurality of tunnels for creating a connection between the user device and the resource; and
create a connection between the user device and the resources via the optimal node and the optimal tunnel.

16. The cloud-based system of claim 15, wherein the determining comprises steps of:
determining an optimal node of the cloud-based system based on a health score of a plurality of nodes; and
determining an optimal tunnel based on the optimal node and on a health score of a plurality of tunnels.

17. The cloud-based system of claim 16, wherein the instructions further cause the one or more processors to determine the health score of the plurality of nodes, wherein a health score of a node is based on Central Processing Unit (CPU) usage, memory usage, and tick slippage of the node.

18. The cloud-based system of claim 16, wherein the instructions further cause the one or more processors to determine the health score of the plurality of tunnels, wherein a health score of a tunnel is based on bandwidth usage and Smooth Round-Trip Time (SRTT) of the tunnel.

19. The cloud-based system of claim 15, wherein the tunnel is an Internet Protocol Secure (IPSec) tunnel between a partner data center and the cloud-based system.

20. The cloud-based system of claim 15, wherein creating the connection includes creating a connection from the cloud-based system to an agent application executing on the user device and creating a connection from the cloud-based system to the resource within the partners data center.
